(19) United States
(12) Patent Application Publication
(10) Pub. No.: US 2003/0064009 A1
(43) Pub. Date: Apr. 3, 2003

(54) Aromatic accessory and method thereof

(76) Inventor: Tracey Baaset, Lithonia, GA (US)

Correspondence Address: MYERS & KAPLAN, INTELLECTUAL, PROPERTY LAW, L.L.C., 1827 POWERS FERRY ROAD, BUILDING 3, SUITE 200,, ATLANTA, GA, 30339, US

(21) Appl. No.: 10/260,766

(22) Filed: Sep. 30, 2002

Related U.S. Application Data
(60) Provisional application No. 60/326,649, filed on Oct. 2, 2001.

(51) Int. Cl. G01N 1/00; B32B 5/02

(52) U.S. Cl. 422/123; 422/120; 422/122

(57) ABSTRACT

An aromatic bag freshener specifically for the interior of various types of carrying bags, including handbags and athletic bags, provides a highly perforated, hollow, decorative holder that allows the insertion and placement of pre-scented material within the holder. Fragrance may escape from the pre-scented material to the ambient environment within the bag through the perforated area of the holder. The holder may take the shape of a teardrop, flower petal, geometric shape, or the like, and extends from a decorative chain, strap or other attachment element with an end hook, pin, or magnetic clasp to fasten the holder to the inside of the bag. The scent carrying material may comprise pre-scented wax-based material, scented molded polymer, formed absorbent carrier material infused with fragrance, or other scented material. The holder, and scented insert are organized into a kit which has a matching color coded position, emotive word, and/or associated name for each fragrance.

### CROSS-REFERENCE TO RELATED APPLICATIONS

The present application claims priority and benefit as a non-provisional application to provisional patent application entitled “Aromatic Bag Freshener” filed on Oct. 2, 2001, having assigned Ser. No. 60/326,649, wherein said application is incorporated herein by reference.

### TECHNICAL FIELD

The present invention relates to a scented or aromatic accessory enabling diffusion of therapeutic and/or freshening aromas within a personal space. More particularly, the aromatic accessory of the present invention comprises a perforated, decorative holder for fragrance-infused material, wherein aromatic scent is released into the surrounding personal space on a sustained basis. The present invention is particularly useful in, although not strictly limited to, applications wherein an individual desires to freshen the interior of a bag, including handbags, athletic sports bags, baby bags, backpacks, brief cases, luggage, and other bags.

### BACKGROUND OF THE INVENTION

Fragrances, perfumes, scented fluids and other fragranced materials have been widely used by both men and women. That use most commonly involves the direct application of fragrance to a person's body or clothes. Perfumed articles for attachment to the body include earrings, broaches, and other jewelry. Articles for attachment to clothing are used for placement in brassieres and other clothing items. Each of these applications is primarily directed to enhancing one's attractiveness to other persons.

Scents and fragrances historically have also been used as air fresheners for the ambient air inside homes or other occupied spaces. These devices typically come in the form of indoor room air fresheners or those used in automobiles. Such air freshener devices may consist of small holders containing air freshening material and can be affixed to a variety of structures, such as visors or door pockets in automobiles, refrigerator doors, and workbenches. These articles are for use in living and working environments and emit fragrance to the ambient air. Many such devices are not refillable and, therefore, it is necessary to replace the entire device to maintain the emission of fragrance for an extended period of time. In some devices of this type, the enclosed fragrance-producing material is quickly depleted or consumed, and many of these devices are large and burdensome and are, therefore, inconvenient for use within the close confines of a personal bag or handbag.

Other articles, such as sachets, have been used for many years as a method of freshening areas smaller in size than room air fresheners, and are used as a method of freshening areas such as drawers or linen closets. Sachets make use of fragrant oil absorbed in vermiculite, wood shavings, botanicals, ground corncobs, or some other absorbent material and are often packaged in envelopes.

None of these aforementioned perfumed articles, jewelry, or air fresheners are particularly useful for providing sustained release of an aroma or fragrance within a personal space, such as the interior of a bag. None of these applications address an individual's interest in freshening with fragrance either their person, their purse, their sports bag which may carry musty clothing, or any other type of bag. None of these devices are appropriately designed for use inside of a bag. The present invention is uniquely different from other perfumed articles, air fresheners, and sachets. The present invention offers the pleasure and therapeutic benefits of aroma for a more unique personal use and enjoyment—the application of fragrance to one's own bag or purse.

Unlike perfumes and other worn fragrances that focus on providing pleasure to others around the user, the present invention is more of a personal care product. It provides an individual aromatic encounter—one to personally experience and enjoy—each time a woman enters her purse or an athlete visits his or her sports bag, or as an ongoing aromatic experience through personal wear of the aroma accessory device.

While no prior art devices are seen to disclose any perfume or fragrance dispensers or other articles having a dispensing structure that is uniquely designed to be attached to and for use within the interior of a bag, the following U.S. patents are instructive:

1. Wearable Perfumed Articles

The prior art discloses elaborate applications of scented fluids to eliminate the necessity for direct contact between the scented fluid and one's skin. By way of example, U.S. Pat. No. 331,937 to W. H. Birge discloses a button, stud, or charm defining a receptacle that may be charged by pouring the scented liquid or fluid into it and carried on the person. U.S. Pat. No. 2,109,092 to Roll discloses a rigid plastic trinket or ornament that is similarly capable of carrying a scent.

Other articles include perfume dispensers for securing to an undergarment, such as a brassiere, as disclosed in U.S. Pat. No. 6,126,085 to Wanzenbock. This patent describes a fragrance dispenser for attachment to an article of clothing (such as an undergarment). The device forms a holder having a pocket from which extends a neck and clip. The pocket accepts a disk of washable material that can be impregnated with a perfume. The disk is held in place by the clip.

The limitations of these devices make them disadvantageous in view of the present invention: (1) they are generally limited in use to the extent that they require the use and handling of volatile fluids which can leak and damage the contents of a bag in which they are used; and, (2) due to their size, they limit the amount of fragrance that can be used, and the low volume of fragrance may quickly dissipate, requiring that the device be frequently recharged.

2. Perfumed Jewelry

The use of essential oils and similar perfumed material in earrings, lockets, and other items of personal jewelry is also well known in the art. Such perfumed ornaments permit the wearer to position a source of fragrance at provocative body locations without the need to constantly reapply the perfumed material as it evaporates.

A variety of arrangements have been developed which employ personal jewelry as a mechanism for dispensing perfume over a period of time. Known and conventional means in jewelry for dispensing perfumed vapors into the atmosphere usually comprise an absorbent pad saturated with perfume located within a cavity in the jewelry.

Numerous patents, including U.S. Pat. No. 3,270,525 to Sellers and U.S. Pat. No. 1,267,067 to Flagg, disclose items of jewelry defining enclosures or receptacles that may be charged with a scented fluid and worn as trinkets, or most commonly as earrings. Many perfumed earring structures show the holder as an integral member, with the perfuming agent carried as an absorbed material in a cotton medium or the like. For example, U.S. Pat. No. 2,058,274 to Vivaudou et al. shows an earring carrying perfumed particles whose odor permeates the ring.

U.S. Pat. No. 2,550,828 to Lawson, Jr. et al. discloses an earring with a compartment for containing an absorbent pad to carry the perfume.

U.S. Pat. No. 1,625,375 to Reyes discloses an earring or breast pin. In U.S. Pat. No. 2,058,274, Vivaudou et al. disclose an earring structure in which the perfuming agent is inserted from the inside of the earring member. As taught by Vivaudou et al., the perfuming agent can constitute a concentrated substance of an organic holding fat or extract with the perfuming essence absorbed therein.

U.S. Pat. No. 2,141,402 to Muller provides an ornamental scenting device in the form of a brooch pin or other item of jewelry. The device provides a means for holding a replaceable scented wad or cartridge. The holding means may be a hinged closure, a screw-in cap, or a plug. A screen is provided opposite the cartridge to allow fragrance to be wafted through the device, and allows the cartridge to be recharged with additional perfume when the cartridge has lost its fragrance, all without opening the case of the device.

U.S. Pat. No. 2,471,949 to Gilowitz discloses an aromatic earring design in which the earring member constitutes a hollow sphere with the perfuming agent disposed therein as a liquid. Cords extend into the liquid and through an aperture at the top of the sphere to carry the liquid perfume into the ambient air. As disclosed by Gilowitz, a flower petal design may then be disposed in conjunction with the extremities of these cords.

These jewelry structures are useful for carrying a perfuming agent therein such that the agent may be dispensed while the jewelry article is being worn. Several features of these articles offer significant drawbacks, however, making them disadvantageous in view of the present invention; namely, they typically contain or involve the use of a substantial amount of perfume and have the potential for leakage of the liquid perfume. The replacement of volatile perfumed oils can potentially cause damage to materials they come into contact with, and, therefore, these devices are not useful for personal wear in direct contact with clothing or for use within the interior of purses or other bags.

3. Air fresheners

Air fresheners are provided in different forms and are used in a variety of locations. These air deodorant or fragrance devices operate on the principal of disseminating some substance into the air. Eventually all of these deodorant devices will dissipate all of the chemicals that create the fragrance and will become useless. These devices are frequently made of molded plastic and contain a volatile fragrant material. Some devices generate a strong fragrance for a short time, but the fragrance is then quickly depleted or consumed and it becomes necessary to replace the entire device. When the fragrant material has lost its effectiveness, it may be replaced or the holder discarded.

While some of these units are recap-able or resealable to preserve the fragrance when the device is not in use, these units are not constructed for application as personal accessory wear or for use within the inner confines of a bag or purse, and do not serve the interest of freshening with aroma the inner environment of a bag on a sustained basis with a decorative article that can be used and used again.

There is a need for a device that can be worn on a person or used inside the interior of a bag, which does not need to be discarded after use, which provides a sustained release of scent, which can be very easily and effectively replaced with a new fragrance medium, and which accommodates the desire for convenience of operation without resorting to messy liquid refills or stocking a clutter of recharge capsules or pellets. The present invention uniquely fills this need.

4. Sachets

Several devices have been patented for packaging scented material. U.S. Pat. No. 2,720,419, issued to Eby, discloses a sachet, having a sealed end portion adjacent to a compartment within the sachet. U.S. Pat. No. 4,905,898, issued to Wade, discloses a combined box and bag package for potpourri. U.S. Pat. Nos. 5,335,433 and 5,197,213, both of which were issued to Borden, disclose decorative frames having compartments for carrying potpourri. U.S. Pat. No. 3,599,859, issued to Maierson, discloses a box for carrying fragrances for release. U.S. Design Pat. No. 368,426, issued to Kaplan, discloses a design of a package for potpourri, and U.S. Pat. No. 5,503,332, issued to Glenn, discloses a scent packet, using a paper envelope.

Sachets in such applications do not lend themselves to use in the interior of a bag. While potpourri sold in paper envelopes can easily fit inside compact spaces like inside of a bag, if handled or disturbed they are subject to tearing or otherwise releasing their contents from the fragile holder. The other types of potpourri packaging devices tend to be cumbersome and large in size and designed to be placed on a surface in the home, such as in the living room, kitchen, bathroom, den, bedroom, etc. With these devices, a problem may arise if the holder or the potpourri comes into direct contact with delicate surfaces. The fragrant oil can potentially cause damage to the finish of leather or other materials in that it may leach out of the paper envelope directly onto the material; thereby, making it undesirable for such potpourricontaining devices to be placed inside of a bag. These devices are not compatible for use inside a bag's interior.

5. Other Devices

U.S. Pat. No. 168,972 to Dayton describes a pocket disinfector and inhaler having perforated metallic case sections, one of which fits into the other, a set of notched and laminated disks of porous material, and an inhaler tube. The disks are disposed centrally within and between the case sections. The apparatus may be suspended through the use of a cord.

U.S. Pat. No. 1,732,028 to Reiner teaches an insect repellent device adapted to contain an insect repellent solution. The two-part case of the device includes apertures which may be opened and closed through relative rotation of sections of the case.

U.S. Pat. No. 3,784,102 to Stults teaches a pendant intended to hold pesticides for use upon pets. A perforated holder is provided for holding a volatile material. The holder and volatile material may be indexed (rotated in fixed increments) relative to one another, so that different portions of the volatile material may be exposed to the perforations until the effectiveness of the underlying volatile material has been exhausted. At that time, a previously covered area of the volatile material is indexed under a perforation to renew the effectiveness of the device.

U.S. Pat. No. 1,988,141 to Schaller discloses a non-leakable liquid sachet. The device includes a metal container made in two parts, one for overlying the other. One case portion has openings. A porous material is contained within the case for retaining the fragrant liquid.

U.S. Pat. No. 2,564,860 to Ryberg teaches a sachet formed from a block of absorbent material, such as diatomaceous earth combined with a suitable binder. The block may be impregnated with a scented liquid. The block may be placed within a container and overcovered with a screen or other perforated housing portion.

U.S. Pat. Nos. 5,422,078 and 5,460,787 to Colon teach an apparatus for providing a scent to a compartment comprising a reusable, perforated holder having a connecting means, and a scented card that may be inserted into a slot within the holder. The scented card is produced according to a process whereby a heat extrudable thermoplastic copolymer material is combined with a blowing agent and a fragrance, and is further processed in order to produce a flat sheet of fragrant material. The material may be cut into any of a variety of shapes and is flexibly rigid to enable it to be inserted into the holder.

U.S. Pat No. 5,806,346 to Schlinger teaches a magnetic pendant necklace set and its method of manufacture. Magnets are used as a clasp to fasten the necklace about the user's neck and also to interchangeably attach different ornamental pendants.

U.S. Pat. No. 6,260,749 to Horovitz teaches a small article holder which uses magnetic means to attach a small article to a user's clothing. A magnet is placed behind the user's clothing, and the article to be secured is placed on the other side. The magnetic force sandwiches the article and magnet to the user's clothing. Objects such as keys or eyewear may be attached.

Unlike the instant invention, none of the current and prior art is seen to be appropriate for use in private space and enclosed interior environments of handbags and other bags.

### BRIEF SUMMARY OF THE INVENTION

The aromatic accessory of the present invention comprises a shaped, hollow holder that includes an attachment at the upper end for placement of an element, such as a chain and hook, pin, magnetic clasp, or other means of carrying or affixing the aromatic accessory to a person or personal article such as a bag.

In a preferred embodiment, a magnetic clasp is used to secure the aromatic accessory in a desired location and/or position. The clasp consists of at least one piece of chain with a magnet on each end. The magnets are configured so as to strongly attract each other. The chain extends from the magnets, wherein the other end thereof is connected to the upper end of the holder.

The holder consists of two pieces which are either secured together on one side to form one unit when closed, or that are not secured together, but that can be placed together to form a closed relationship. The backside of the holder is perforated to allow sufficient venting of fragrance from the pre-scented insert placed inside the holder. The front side of the holder may be formed of two sections welded, molded, or snapped together, one piece being the perforated area of the front side, and the other piece being a solid face which can accommodate the placement of trade name and/or decorative indicia or characteristics. Such decorative indicia or characteristics may consist of beads, synthetic gems or rhinestones, or other ornamental designs.

The perforated area of the holder can preferably occupy up to 75% of the entire surface of the holder and can be in varying density and concentration of holes or perforations sufficient or desirable for the release of fragrance, wherein the remaining non-perforated area of the holder can accommodate decorative indicia or ornamental design. The holder can also be formed having perforations defined through greater than 75% of the surface area of the holder, wherein lesser non-perforated surface area is desirable. The holes or perforations can take any size, form, or shape.

In a preferred embodiment, the holder comprises two sides, front and back. The holder opens on one side, the opposite side being flexibly, but permanently, attached to the other by means of hinges or other connectors. A pre-scented material is inserted securely into the front or backside of the hollow holder. A channel may be provided for such purposes.

The pre-scented material is preformed to a shape that will fit easily into the holder. Perforations within the insert create a larger surface area for airflow through the scented insert, which, in turn, allows the scent to be dispersed more effectively.

The insert and its packaging are preferably color coded and matched to form a kit. Within the kit, each insert is provided in a unique color, with an associated emotive word, and uniquely named fragrance. The package is arranged so as to allow the user to identify the other matching attributes when only one of the attributes are known. The colors and fragrances may be selected from any suitable color or fragrance. The words may be selected from any suitable emotive words; by way of non-limiting example, “passion,” “peace,” “prosperity,” or “love.” Additionally, unique fragrance names are utilized to convey the emotion, or aromatic benefit, of the fragrance such as, for exemplary purposes only, AURABLISS for peace, MYSTACY for passion, and CINCHI for prosperity.

A first alternate embodiment provides a hollow holder with top and bottom sections. The two sections can be placed together at the edges to form a closed relationship. The solid, formed bottom section of the holder has a depth sufficient to carry a solid pre-scented material. The bottom section of the holder is put in place once the fragranced material is inserted into the top section of the holder. Again, a channel may be provided for such purposes.

A second alternate embodiment presents a perforated holder with an open mouth at the bottom of a teardrop shape. A solid, formed bottom section is attached by a hinge and is operable to clamp to the front portion of the holder to enclose and secure a pre-scented material within the holder.

Other embodiments comprising various shapes, such as a heart, star, baseball, or the like, are also possible.

In each representative embodiment, the pre-scented insert is replaceable, so that when the scent in the fragrant material is eventually dissipated, a new pre-scented insert may be placed within the holder. In use, the consumer simply obtains additional replacement inserts to be used in the reusable holder.

The insert may be formed of pre-scented, wax-based material, molded or extruded fragranced polymer, or made of absorbent carrier material, or may be made of any other suitable aromatic diffusing material.

The present invention is reusable in that it permits the replacement of the scent carrier within the holder and is constructed of high quality materials that do not need to be discarded after use. The holder is of two or more parts, and constructed of plated cast or stamped metal, extruded or molded plastic, lithographed tin or other materials, including precious metals.

The decorative aspect of the external part of the highly perforated holder may be provided by floral design, by abstract art forms, or by the use of solid color or patterned designs. The solid portion of the holder may alternately be engraved, or otherwise enameled in various colors, or may have applied thereto decorative beads, synthetic gems, rhinestones, or the like.

It will be recognized that, while several of the drawings show the holder to be teardrop shaped, this shape is illustrated as only one of many varying and acceptable shapes for the invention. Accordingly, it is to be understood that an indefinite number of other decorative shapes can be provided and used without departing from the scope of the present invention and its preferred embodiments. For example, other decorative shapes can be provided, such as floral shapes, geometric shapes, and various shapes of sporting equipment and other paraphernalia.

Similarly, the attachments to the holder, including the chain and hook, pin, or magnetic clasp used to attach to a person, a person's clothing, and/or to a bag may be made of any suitable materials including plastic, aluminum, steel, beads, semi-precious stones, or of precious metals, as desired. The magnets will of course be made of suitable magnetizable material.

The article is fashioned to house and hold pre-scented material of a solid nature. The solid pre-scented material is formed, sized, and shaped in a manner to be accommodated within the various diverse shapes of the holder. The user opens the sections of the holder, inserts the pre-scented insert into the holder, and re-closes the sections of the holder.

The holder is perforated so as to provide the effect of a mesh, screen, or other highly dense hole or perforation pattern in order to permit the escape of the fragrance throughout the perforated area.

The present invention, then, overcomes the limitations of prior art devices, which are not ideally suited to provide fragrance within a personal space or within the interior of a bag. The benefits of the present invention overcome these limitations by providing, without the use of volatile fluids, an ornament of lightweight construction that holds a pre-scented solid material capable of permitting the escape of fragrance proximate to one's person and/or inside of purses, handbags, athletic bags, backpacks, briefcases, and other bags to enhance with aroma the close personal environment of the user.

Accordingly, it is the object of the present invention to provide a unique aromatic accessory for placement or attachment in the interior of purses, handbags, athletic bags, backpacks, luggage and other bags, that will emit fragrant scent on a sustained basis for a period of time.

Another object of the present invention is to provide a unique aromatic accessory for personal wear that will emit fragrant scent on a sustained basis for a period of time, thereby refreshing personal space.

Another object of the present invention is to provide an aromatic accessory that is a personal fragranced bag freshener that can be attached or affixed to, but easily removable from, the inner edge, inner pocket, zipper, lining or other part of the interior of a bag.

Still another object of the present invention is to provide a scent-emitting accessory that can be utilized again and again by inserting replacement fragrance carriers into the scent holder.

Yet another object of the present invention is to provide an aromatic accessory that consists of a decorative holder constructed of lasting materials and that is aesthetically pleasing in its external appearance.

Yet still another object of the present invention is to provide an aromatic accessory of various designs and sizes appropriate for personal wear and/or placement inside various types, sizes and uses of different bags.

An additional object of the invention is to provide a fragrance-emitting accessory that does not involve adding volatile fluids in order to eliminate the risk that scented oils will leak or leach therefrom and cause damage to the contents in or material of a bag and/or to the clothing of a wearer.

A further object of the present invention is to provide an aromatic accessory which is inexpensive and easy to manufacture, as well as easy to use and maintain.

It is yet a further object of the present invention to provide an aromatic accessory contained in a kit which has a color coded scented insert corresponding to a position, color, an emotive word associated with the packaging of the kit, and a unique fragrance name to convey the aromatic benefit, or emotion, of the fragrance.

Other objects, features, and advantages of the present invention will become apparent to those skilled in the art by reference to the drawings and to the detailed description of the preferred embodiment presented herein.

### BRIEF DESCRIPTION OF THE DRAWINGS

The invention is better understood by reading the Detailed Description of the Preferred Embodiments with reference to the accompanying drawing figures, in which like reference numerals denote similar structure and refer to like elements throughout, and in which:

FIG. 1 is a front view of the preferred embodiment of the aromatic accessory of the present invention showing the two halves of the holder in an open position with the solid area, perforated areas, hinges, clasp and attaching chain visible;

FIG. 2 is a side view of the holder of the aromatic accessory of the present invention in a closed position showing the solid area, perforated areas and attaching chain;

FIG. 3 is a sectional view of the preferred embodiment of the aromatic accessory of the present invention showing the hollow interior of the holder, hinges, and clasp;

FIG. 4 is a perspective view of the first alternate embodiment of the aromatic accessory of the present invention showing the snap on bottom, perforated area, and hollow area for containing scented material;

FIG. 5 is a perspective view of the bottom of the first alternate embodiment of the aromatic accessory of the present invention showing the concave area where scented material is contained;

FIG. 6 is a front view of the first alternate embodiment of the aromatic accessory of the present invention showing the top and bottom of the holder snapped together, perforated area, and attaching chain;

FIG. 7 is a side perspective view of the second alternate embodiment of the aromatic accessory of the present invention showing the bottom hingedly attached to the top, clasp, perforated area, and attaching chain;

FIG. 8 is a back view of the second alternate embodiment of the aromatic accessory of the present invention showing the bottom, hinges, perforated area, and attaching chain; and,

FIGS. 9athrough 9f illustrate some of the different and varying shapes in which the holder of the aromatic accessory of the present invention could be made.

FIG. 10 is a front view of the holder of the aromatic accessory of the present invention attached to the magnetic clasp by a piece of chain. The clasp is shown in an unlatched position.

FIG. 11 is a front view of the aromatic accessory of the present invention attached to the magnetic clasp by two pieces of chain, showing the clasp in the latched position.

FIG. 12 is a perspective view of the package for the holder of the aromatic bag freshener of the present invention showing the holder, insert, and words on the package.

FIG. 12a is a front view of the scented insert showing the perforated area in the insert.

The accompanying drawing Figures and the description that follows set forth this invention in its preferred embodiments. It is contemplated that persons generally familiar with fragrance emitting devices and ornaments will be able to apply the novel characteristics of the structures illustrated and described herein in other contexts by modification of certain details hereof. Accordingly, the drawings and description are not to be taken as restrictive of the scope of this invention, but, rather, are to be understood as broad and general teachings.

### DETAILED DESCRIPTION OF THE PREFERRED EMBODIMENT

In describing preferred embodiments of the present invention illustrated in the Figures, specific terminology is employed for the sake of clarity. The invention, however, is not intended to be limited to the specific terminology so selected, and it is to be understood that each specific element includes all technical equivalents which operate in a similar manner to accomplish a similar purpose.

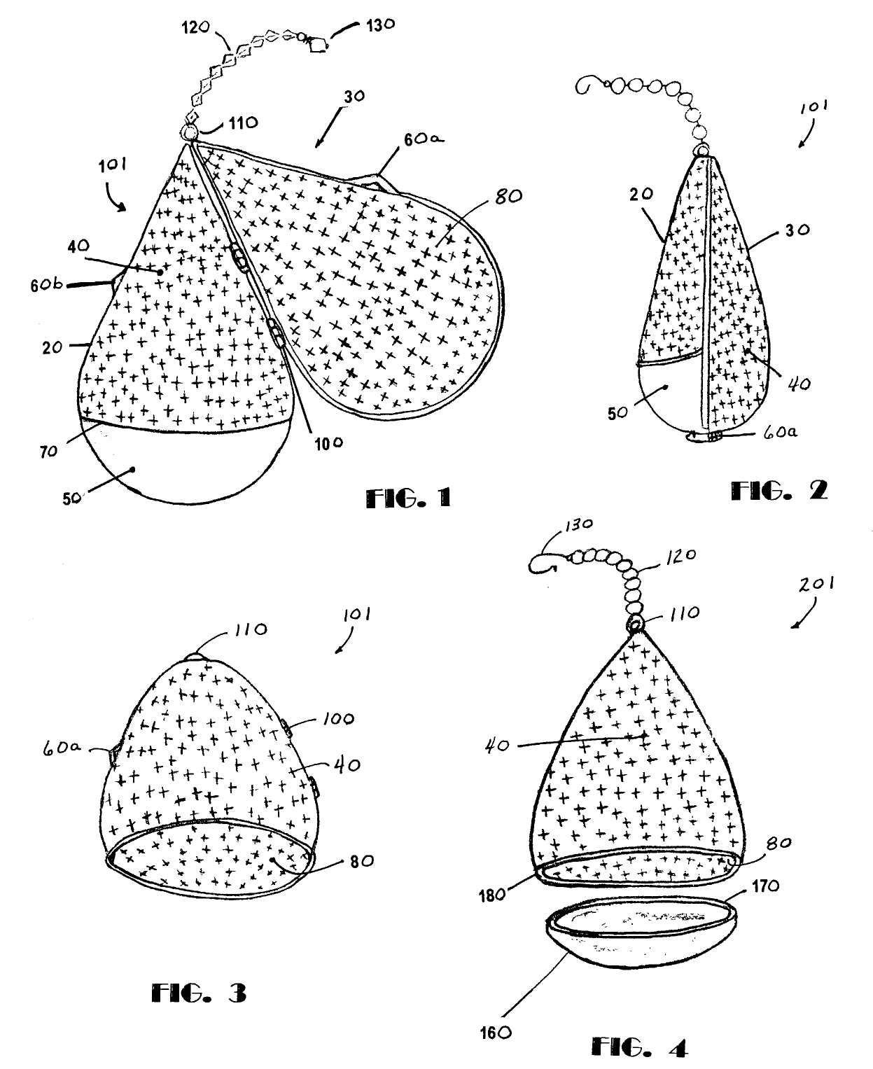

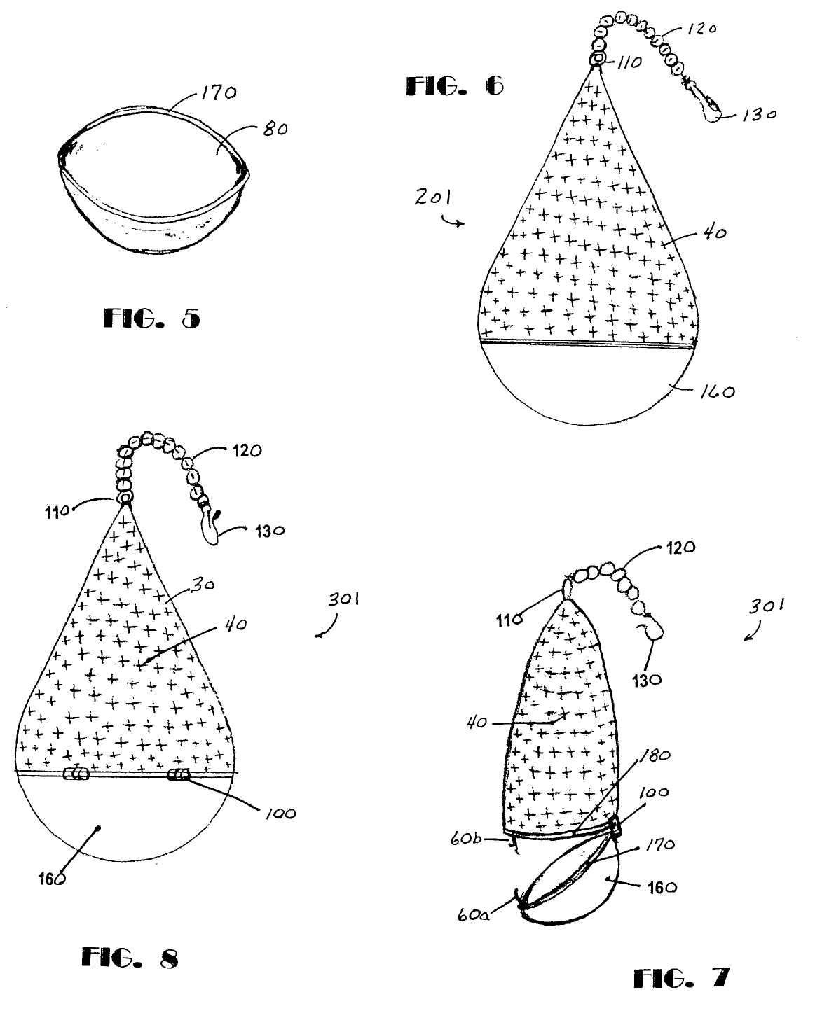

With reference first to FIGS. 1 through 3, in a preferred embodiment, locket or holder 101 is made of two sections 20, 30. Front section 20 contains perforations 40 and solid area 50. Trade dress or decorative indicia may is be printed, engraved, or applied on solid area 50. Back section 30 is fully impressed with perforations 40. The perforated areas of holder 101 can be constructed of mesh, screen, or other material that provides for highly dense holes or perforations to permit the emission of the scent through perforations 40. Preferably, perforations 40 may be formed within the base material of holder 101 to permit the emission of scent therethrough.

When sections 20, 30 are assembled, they fit together securely and appear as one piece; thereby, forming hollow, concave interior 80. For convenience of assembly, sections 20, 50 may be joined at 70 by welding, if made of metal, or by molding, glue, or bonding agent, if plastic, or formed of a single-piece construction.

A pre-scented insert 160 is placed inside holder 101 and may be made of the following materials: pre-scented wax-based material; molded or extruded fragranced polymer; absorbent carrier material; or, may be made of any other suitable aromatic diffusing material. The pre-scented insert 160 is sized, shaped, and formed to centrally occupy the hollow interior 80 of the holder. Perforations 170 in insert 160, best seen by reference to FIG. 12a, create a larger surface area for air flow through the insert, which allows the scent to be dispersed more effectively. Perforations 40 in both sections 20, 30 of holder 101 allow the scent from the scented material to escape from holder 101 into the surrounding atmosphere in order to freshen the target area which may be clothing, a gym bag, purse, or one's person. As shown in the Figures, in the preferred embodiment, as much as 75% of the entire holder may be perforated. However, one skilled in the art would readily recognize that any amount of perforations, including approximately 75% of the entire holder, could also be utilized. Back section 30 may be perforated as much as approximately 90%, while approximately 50% or more of the front section 20 will likewise be perforated.

Front and back sections 20, 30 of holder 101 may be connected by use of hinge 100, spring-back hinge, or other flexible closure means, all of which are well known in the art. Additionally, front and back sections 20, 30 of holder 101 may be slidably related. Such closure means can be placed on any side joining the two sections. Front and back sections 20, 30 can be connected to one another on any side of the holder; the location and number of hinges 100 or other flexible closure is limited only by the shape and structural integrity required of the holder. Hinge 100 joining front section 20 and back section 30 of holder 101 provides the means by which the holder freely opens to allow the placement of the pre-scented insert and closes to secure the placement of the pre-scented insert within the holder. Clasps 60a, 60b or clip may be used on the opposite side of holder 101.

Ring 110 or other connecting means affixed to the top of holder 101 provides for the attachment of a decorative chain 120, cord, string, ring, or other attachment element to be used for hanging the holder from a person or from the strap or other receiving member of a purse or other bag. Attached to chain 120, cord, or string is fastener 130 such as a hook, clip, clasp, or other suitable fastener or connecting means for the holder's removable attachment thereof. It will be apparent to those ordinarily skilled in the art that chain 120 may be affixed to ring 110 by any of a variety of ancillary, removable attachment means known in the art, such as retractable spring-loaded clasps, lobster claw clasps, or the like.

With reference next to FIGS. 4 through 6, in a first alternate embodiment, hollow holder 201 comprises many of the features of the preferred embodiment, including perforations 40, ring 110, chain 120, and fastener 130. Unlike the preferred embodiment, however, this embodiment is split on a horizontal axis, rather than on a vertical axis. Bottom 160, demonstrated as a rounded concave solid form, contains lip 170 which cooperatively snaps onto top 180 to form holder 201. No hinges or clasps are required in this embodiment. Bottom 160 provides a sufficient depth to create a space wherein the bottom of the pre-scented insert may rest.

Referring next to FIGS. 7 and 8, in a second alternate embodiment, holder 301 comprises many of the features of the previous two embodiments, including perforations 40, ring 110, chain 120, and fastener 130. This embodiment is split on a horizontal axis, just as was the preceding embodiment. This embodiment, however, does not have a snap-on bottom. Instead bottom 160 utilizes hinge 100 and clasps 60a, 60b to attach bottom 160 to top 180.

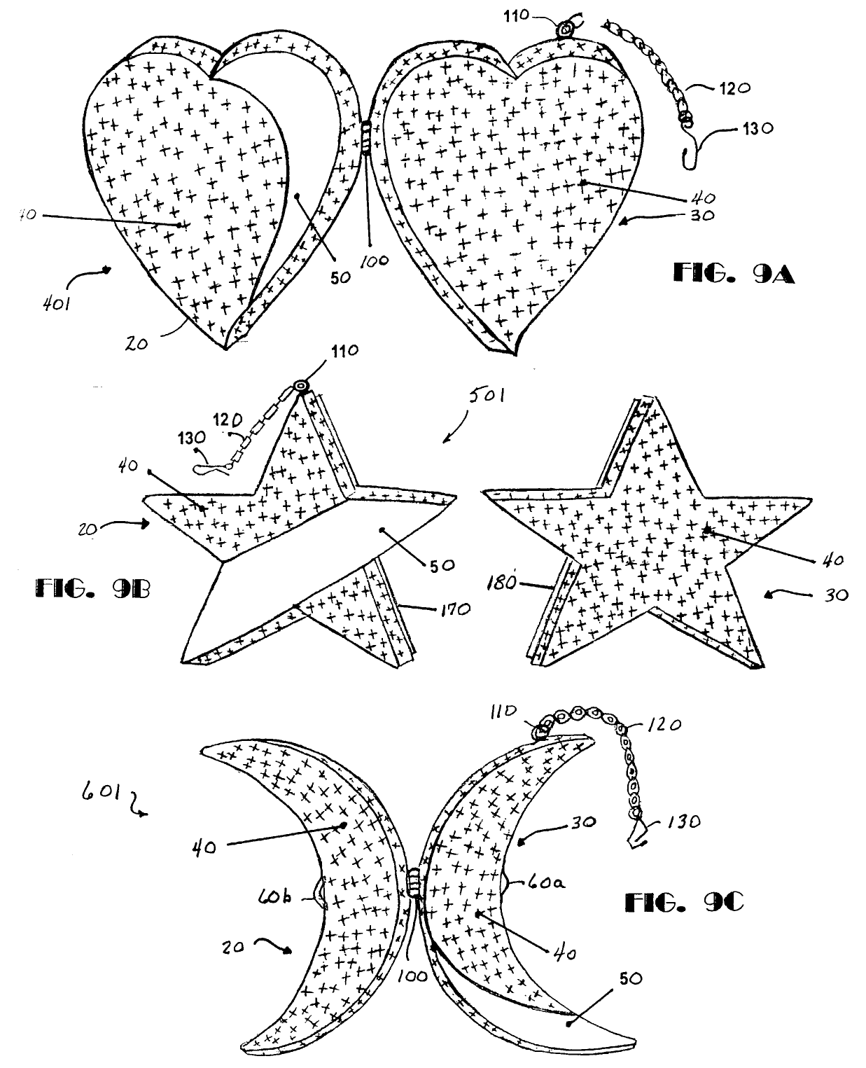

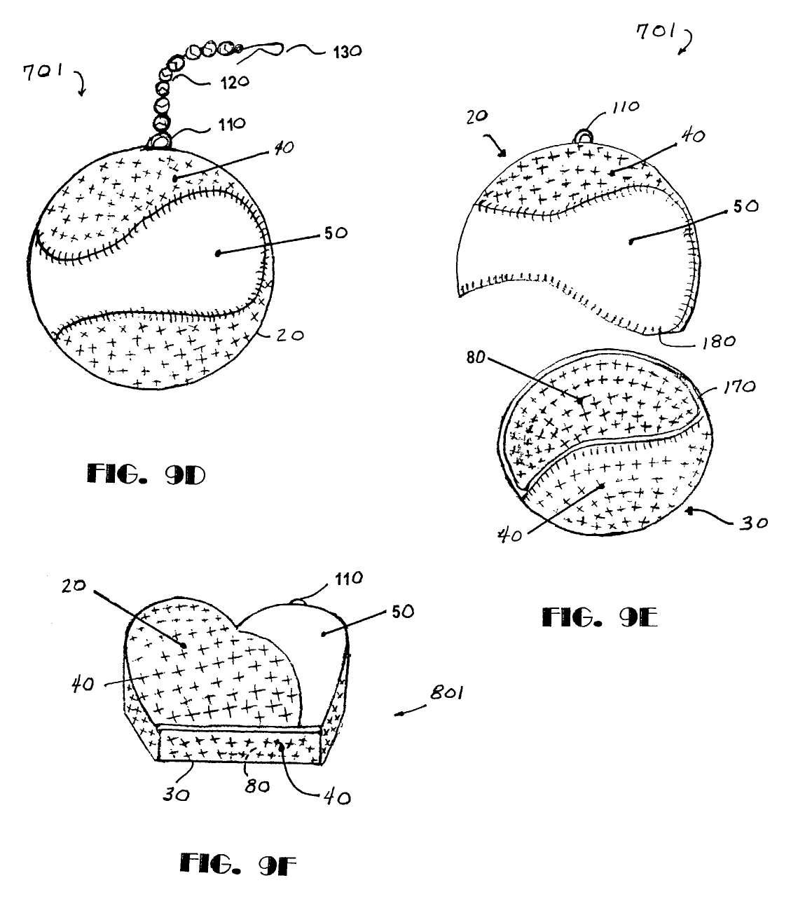

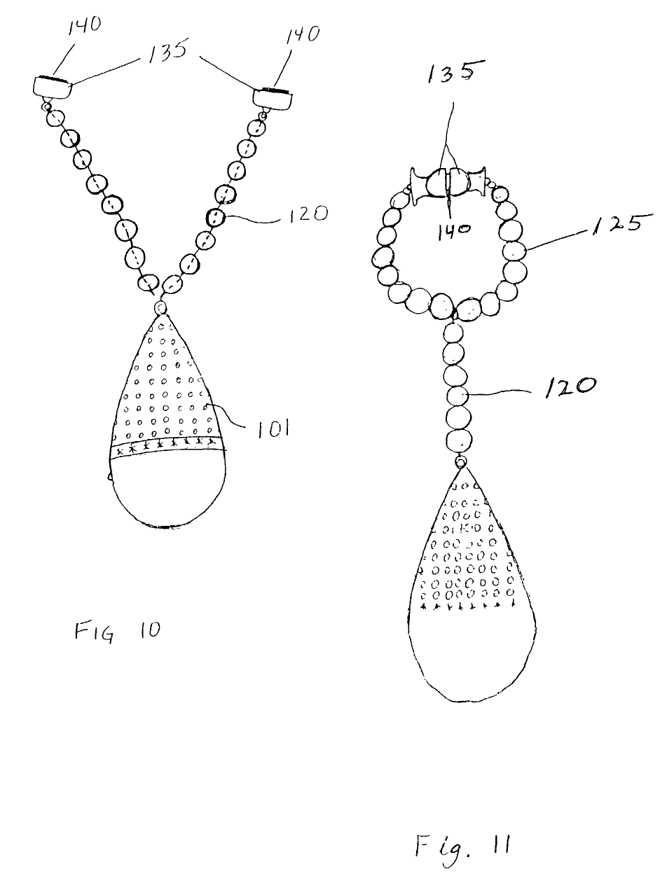

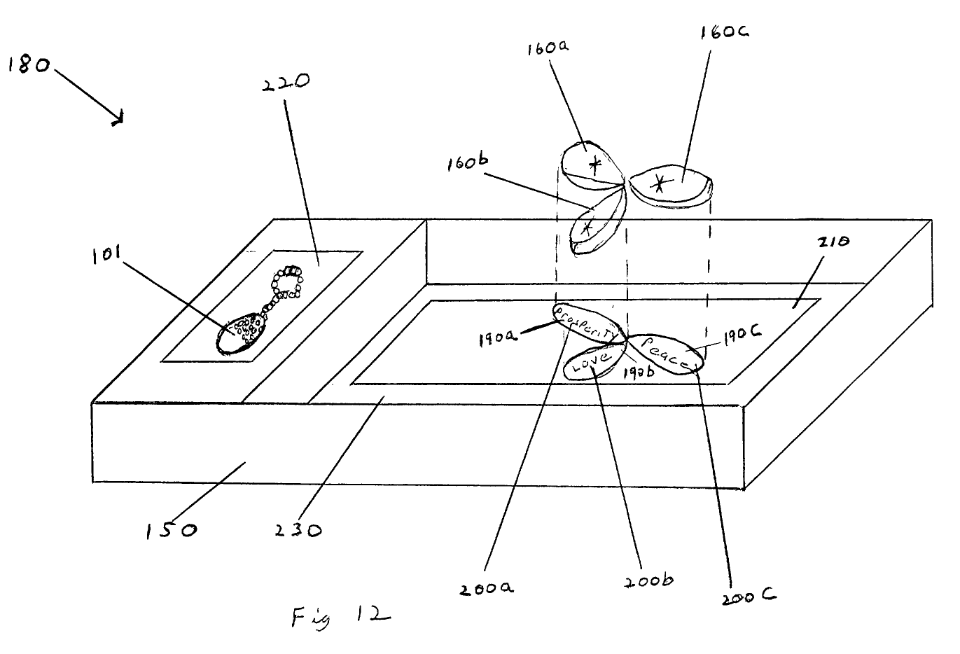

FIGS. 9A through 9F present further alternate embodiments of holder 401, 501, 601, 701, and 801 of the present invention in other shapes for use in various types of bags, including briefcases and sports bags. The features common between these holders are perforations 40, and hollow interior 80, the interior space being sufficient for the placement of a pre-scented insert 160. The prescented insert 160 is sized, shaped, and formed in a manner consistent for use with the provided holder shape. Each holder is formed of at least two sections, front section 20 and back section 30, or top section 20 and bottom section 30. Perforations 40 permit the escape of fragrance contained in the pre-scented insert that will be placed inside the holder. Up to approximately 30% of the holder, however it may be shaped, will preferably form solid area 50 on the front facing of the holder for the placement of decorative indicia, characteristics, or trade dress. However, one skilled in the art would readily recognize that any amount of solid area can be incorporated, including solid area greater or less than 30% of the holder.

The various sections of holder 101 may be connected to one another by means of hinge 100 or other flexible closure. The various sections of holder 101 may, alternatively, be separate from one another but have the capacity for the edges of each piece to fit tightly against the other piece at the lip, all as described with regard to previous embodiments hereof.

The embodiments presented in FIGS. 9A through 9F are merely illustrative of the many and varying decorative shapes and forms that holder 101 of the present invention can take. Pre-scented material 160 will be sized, shaped, and formed to centrally occupy hollow interior 80 of holder 101 when sections 20, and 30 are closed together.

Attached to the top of holder 101 by ring 110 or other connecting means is decorative chain 120, cord, or string which may be used for hanging holder 101 from a person or from a purse or other bag. Attached to chain 120 is fastener 130 such as a hook, clip, clasp, or other suitable fastener for the holder's removable attachment thereof.

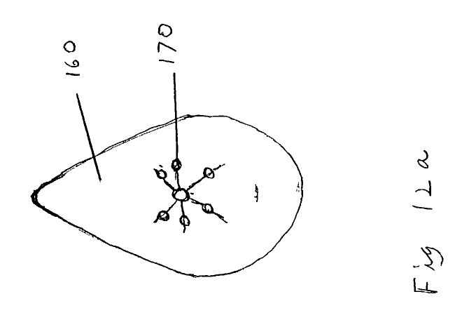

Referring now to FIG. 10, holder 101 is shown attached to magnetic clasp 135 by a piece of chain 120, and in FIG. 11, holder 101 is shown attached to magnetic clasp 135 by two pieces of chain 120, 125.

Magnetic clasp 135 may be used in place of fastener 130 to secure holder 101 to the desired bag, purse, or briefcase. Clasp 135 consists of at least one piece of chain 120 or 125 with magnet 140 on each exposed end. Magnets 140 are configured so as to strongly attract each other. The opposite end of chain 120 is connected to the upper end of holder 101.

With reference to FIG. 11, when fastened, chain 125, as attached to clasp 135, defines a circular shape. The area of chain 125 opposite clasp 135 has an additional chain 120 connected thereto. The opposite end of additional chain 120 is connected to the upper end of holder 101.

FIG. 10 shows clasp 135 in a latched position. FIG. 11 shows clasp 135 in an unlatched position. Magnetic clasp 135 may be used with any of the various embodiments of this device.

Referring now to FIG. 12, preferred package 150 is color-coded and matched to form kit 180. Within kit 180 is provided card 210. Card 210 is dimensioned to fit into compartment 230. Scented inserts 160a, 160b, 160c are provided for affixation to card 210, as in a bubble pack, blister shell, or other suitable packaging well-known in the art. Card 210 provides an associated color position 190a, 190b, 190c, an associated emotive word 200a, 200b, 200c for each corresponding scented insert 160a, 160b, 160c, and a unique fragrance name for each corresponding scented insert 160a, 160b, 160c. In this form, package 150 is arranged so as to allow the user to identify the other matching attributes when only one of the attributes are known.

Colors 190 and fragrances within scented insert 160 may be selected from any suitable color or fragrance. Words 200 may be selected from any suitable emotive words; by way of non-limiting example: “passion,” “peace,” “prosperity,” or “love.” Additionally, unique fragrance names are utilized to convey the emotion, or aromatic benefit, of the fragrance such as, for exemplary purposes only, AURABLISS for peace, MYSTACY for passion, and CINCHI for prosperity.

Package 150 preferably is formed into two compartments 220 and 230. Compartment 220 is sized to hold housing 101, chains 120 and/or 125, and clasp 60. Compartment 230 is sized to hold emotive words 200, scented inserts 160 having unique fragrance names, and color positions 190 which are integral with card 210.

It will be appreciated by those ordinarily skilled in the art that package 150 may be used with any of the several embodiments of this invention. Similarly, scented insert 160 may be any suitable shape and size as may be accommodated by holder 101.

In use, package 150 is selected by the user. Housing 101 is removed from compartment 220. A suitable insert 160 comprising a uniquely-named fragrance matching the emotive state, or desired emotive state, of the user is chosen and removed from card 210. Scented insert 160 is placed into housing 101. Housing 101 is worn by the user or is placed into or onto the bag the user wishes to freshen and is fastened into place by use of clasp 60. Should the user wish to change fragrance or emotive response evoked by the fragrance of the device, the user simply removes scented insert 160, returns it to card 210 according to color, emotive word, or position, and reselects another scented insert 160 from one of the remaining scented inserts 160.

Having thus described exemplary embodiments of the present invention, it should be noted by those skilled in the art that the within disclosures are exemplary only and that various other alternatives, adaptations, and modifications may be made within the scope of the present invention. Accordingly, the present invention is not limited to the specific embodiments as illustrated herein, but is only limited by the following claims.

I claim:

1. An aromatic bag freshener for the interior of various types of carrying bags, including handbags and athletic bags, comprising:
a substantially hollow, decorative holder that allows for the insertion and placement of pre-scented material within said holder;
said holder comprising a holder in two cooperatingly joinable portions, a first portion of which comprises a substantially imperforate decorative region over greater than approximately thirty percent of said holder, and a second portion which comprises a highly perforate portion over approximately seventy percent of said holder; and,
attachment means.

2. The bag freshener of claim 1 further comprising a pre-scented material within said holder.

3. The bag freshener of claim 2 wherein said holder and pre-scented material are contained within a kit, said kit further comprising a matching color coded position and emotive word for each pre-scented insert.

4. The bag freshener of claim 2 wherein said pre-scented material is selected from the group consisting of one or more of: wax-based material, scented molded polymer, formed absorbent carrier material infused with fragrance, or other scented material.

5. An accessory for holding and dispensing a fragrance, comprising:
a shaped, hollow holder;
a linking means carried by said holder; and,
an attachment means carried by said linking means, said attachment means enabling removably secure placement of said holder.

6. The accessory of claim 5, wherein said linking means is a chain and said attachment means is a magnetic clasp.

7. The accessory of claim 5, wherein said holder has a first piece and a second piece, wherein said first piece and said second piece are hingedly related, and wherein at least one portion of at least one said piece of said holder is perforated.

8. The accessory of claim 7, wherein said holder has an interior channel, said interior channel cooperating in the retention of the fragrance.

9. The accessory of claim 5, further comprising a pre-scented material, wherein said pre-scented material is shaped and dimensioned to fit within said shaped, hollow holder.

10. The accessory of claim 9, wherein said pre-scented material is perforated.

11. The accessory of claim 10, wherein said pre-scented material is wax-based.

12. The accessory of claim 11, wherein said pre-scented material is fragranced polymer.

13. An aromatic accessory kit, comprising:
an accessory for holding and dispensing fragrance;
a plurality of aromatic inserts, each said insert dimensioned to reside within said accessory for holding and dispensing fragrance;
a package, said package having a receptacle for said accessory and a plurality of receptacles for said plurality of aromatic inserts, wherein each said receptacle of said plurality of receptacles and each said corresponding aromatic insert of said plurality of aromatic inserts are color-coded and wherein each said receptacle of said plurality of receptacles and each said corresponding aromatic insert of said plurality of aromatic inserts have at least one emotive word associated therewith.

14. The aromatic accessory kit of claim 13, wherein said receptacle for said accessory is a first compartment, and wherein said package has a second compartment and a card, wherein said card is dimensioned to be received within said second compartment and said card carries said plurality of receptacles for said plurality of aromatic inserts.

15. A portable aromatic accessory, comprising:
a locket having a first section and second section, wherein said first section and said second section relate to define an accessible inner compartment, wherein at least one said section has a plurality of airflow apertures defined therein, and wherein at least one said section comprises at least one portion of generally solid surface area;
a connector, said connector carried by said locket proximate to a first end thereof;
at least one generally elongated element, said at least one generally elongated element carried by said connector and said at least one generally elongated element having two distal ends;
a magnetic clasp having two cooperating magnetic portions, wherein said cooperating magnetic portions are carried by said distal ends of said generally elongated element; and,
an aromatic insert, said aromatic insert shaped to be carried within said accessible inner compartment of said locket.

16. The portable aromatic accessory of claim 15, wherein said at least one portion of generally solid surface area of at least one said section of said locket carries indicia.

17. A method of refreshing personal space, comprising the steps of:
a) obtaining an aromatic kit having a locket with a clasp depending therefrom, a plurality of fragranced inserts for placement within said locket, each said fragranced insert of said plurality of fragranced inserts having an emotive word associated therewith;
b) removing said locket from said kit;
c) selecting a fragranced insert from said plurality of fragranced inserts;
d) placing said selected fragranced insert within said locket;
e) selecting a position for said locket within or upon a user-desired personal space location; and,
f) fastening said clasp to or about said location.

18. The method of refreshing personal space of claim 17, further comprising the steps of:
g) removing said selected fragranced insert from within said locket;
h) selecting another fragranced insert from said plurality of fragranced inserts; and,
i) placing said selected fragranced insert within said locket.
